(19) United States
(12) Patent Application Publication
(10) Pub. No.: US 2024/0033740 A1
(43) Pub. Date: Feb. 1, 2024

(54) DIGITAL MICROFLUIDIC DEVICE INCLUDING TEMPERATURE ZONES

(71) Applicant: HEWLETT-PACKARD DEVELOPMENT COMPANY, L.P., Spring, TX (US)

(72) Inventors: Evan Kirshenbaum, Palo Alto, CA (US); Viktor Shkolnikov, Palo Alto, CA (US)

(73) Assignee: HEWLETT-PACKARD DEVELOPMENT COMPANY, L.P., Spring, TX (US)

(21) Appl. No.: 17/877,342

(22) Filed: Jul. 29, 2022

(51) Int. Cl. B01L 3/00; B01L 7/00

(52) U.S. Cl. CPC B01L 3/502784; B01L 3/50273; B01L 7/52; B01L 2400/0427; B01L 2300/18

(57) ABSTRACT

A digital microfluidic device includes an array of controllable electrode pads alignable with a fluid passageway and a control portion. The control portion is to cause electrowetting movement of a droplet within the fluid passageway through a circuit of multiple different zones of the electrode pads. The electrowetting movement is to iteratively expose the droplet within a current zone of the different zones for a selectable current time period at a current temperature of a list of consecutive temperatures, further expose the droplet within the current zone, for each respective selectable subsequent time period, at each respective subsequent temperature of the list which is greater than the current temperature, and move the droplet into a subsequent zone of the different zones when one of the respective subsequent temperatures is less than the current temperature.

### BACKGROUND

Microfluidic devices have revolutionized some aspects of modem medicine. For example, microfluidic devices have been used to perform molecular diagnostics in order to better detect infectious diseases, obtain genetic information, perform pharmacogenomics, facilitate oncology, and for other purposes.

### BRIEF DESCRIPTION OF THE DRAWINGS

FIG. 1 is a diagram schematically representing an example device and/or example method including an array of controllable electrode pads to perform multi-zone, multiple temperature phase thermal cycling.

FIG. 2A is a block diagram schematically representing an example control portion.

FIG. 2B is a partial sectional side view schematically representing an example microfluidic device including a temperature control element.

FIG. 3 is a sectional side view schematically representing an example microfluidic device including a receptacle defining a fluid passageway and an electrode control element including controllable electrode pads.

FIG. 4 is a top view schematically representing an example device and/or example method including an array of controllable electrode pads to perform multi-zone, multiple temperature phase thermal cycling.

FIGS. 5-6 are each a top view schematically representing an example device (and/or example method) including an array of controllable electrode pads for shuttling droplets without mixing the droplets with each other.

FIGS. 7A-8 are each a top view schematically representing an example device (and/or example method) including an array of controllable electrode pads for shuttling droplets, including mixing droplets and splitting droplets.

FIG. 9 is a diagram schematically representing an example device and/or example method including an array of controllable electrode pads to perform multi-zone, multiple temperature phase thermal cycling.

FIG. 10A is a sectional side view schematically representing an example microfluidic device including a receptacle defining a fluid passageway and an electrode control element which is releasably couplable relative to the receptacle.

FIG. 10B is a side sectional view schematically representing an example non-contact charge applicator.

FIG. 11A is a block diagram schematically representing an example fluid operations engine.

FIG. 11B is a block diagram schematically representing an example control portion.

FIG. 11C is a block diagram schematically representing an example user interface.

FIG. 12 is a flow diagram schematically representing an example method of performing multi-zone, multiple temperature phase thermal cycling.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

Among other purposes, molecular diagnostics may help identify infectious diseases. One class of molecular diagnostics includes a nucleic acid amplification test such as, but not limited to, a polymerase chain reaction (PCR) assay to amplify target genomic material for detection. One common use of such PCR testing is for detecting viral genomic material such as, but not limited to, detecting a virus like Severe Acute Respiratory Syndrome Corona Virus 2 (SARS-CoV2), which may sometimes be referred to as COVID-19 (i.e. Corona Virus Disease of 2019).

In some examples, the nucleic acid amplification may be used in DNA synthesis (e.g. gene editing), DNA sequencing, such as for bio analysis and bio fabrication, or for other purposes.

In general terms, such nucleic acid amplification may be used to make many copies of a genetic sample in order to greatly increase the accuracy and reliability of detection of the analyte of interest, such as viral genetic material. One measure of the effectiveness of such nucleic acid amplification may comprise a limit of detection, which may informally be referred to as the lowest concentration of an analyte that can be reliably detected. In general terms, the lower the limit of detection, the more accurate and reliable the test such that fewer false negatives are reported.

In general terms, the PCR assay is carried out by isolating nucleic acid strands, such as DNA strands or RNA strands, from a sample from biological material and adding it to a PCR master mix for use in a receptacle (e.g. well, fluid passageway) of a testing device to form a PCR mixture. Biological materials may comprise human, animal, microbial, or plant biological material. In some examples, the biological material may be obtained from a human patient sample.

In most instances, because of complexity, cost, and other factors, the testing device may be located in a laboratory. However, some testing devices may be mobile and deployable in the field, such as at a point-of-care. In view of the considerable societal impact caused by some infectious diseases, providing faster and/or more mobile testing may ease the impact of such diseases by enabling early detection, tracking patterns of disease migration, treatment effectiveness, and public health decision-making.

With further reference to the actual testing, in some examples a PCR master mix, to which a sample of biological material (e.g. a biological sample) is added to form a PCR mixture, may comprise components to execute the basic steps of a polymerase chain reaction via thermal cycling within an appropriately sized receptacle, which may comprise a test well, fluid passageway of a digital microfluidic (DMF) testing device, fluid cavity, or other container. This combination of the PCR master mix and the genetic sample may be sometimes be referred to as a PCR mixture or a PCR sample volume. In some instances, a PCR sample volume may comprise about 25 to about 50 microliters and a testing device may provide for testing a group of wells arranged as a well plate or well chip. However, in some examples the PCR sample volume may be made available to (or within) a testing device as a plurality of droplets, such as within a digital microfluidic (DMF) device. Via the testing device, a combination of the biological sample and the PCR master mix comprises the PCR sample volume, which is heated in a manner to perform the PCR assay.

Among other components, in some examples a PCR mixture may comprise a template nucleic acid sequence (e.g. DNA strands, RNA strands, portions thereof) and a PCR master mix, which may comprise buffers, dyes, cofactors, beads, primers (e.g. forward primer, reverse primer), probes, deoxyribose nucleotides (dNTPs), and/or enzyme DNA polymerase. The template nucleic acid sequence corresponds to the known target nucleic acid sequence to be amplified. In some examples, the enzyme DNA polymerase may comprise a Taq DNA polymerase such as a thermophilic eubacterial microorganism (Thermus aquaticus). In some examples, the cofactor may comprise Magnesium Chloride or Magnesium Sulfate. In some examples, the water may comprise nuclease-free water or PCR-grade water. In some instances, the PCR master mix also may be referred to as a PCR super mix or a PCR ready mix. Once the components appropriate for a desired type of PCR test are selected, they are added at appropriate concentrations in combination to prepare a batch mixture, which is then divided among multiple PCR wells. A volume of a PCR mixture (i.e. PCR sample volume), which includes the genetic sample and the PCR master mix per well may comprise 25 to 50 microliters (μL). At least some example PCR master mixes are available commercially from a number of sources such as, but not limited to, Sigma-Aldrich, Inc. of Saint Louis, Missouri, United States or at www.sigmaaldrich.com.

A PCR assay test involves thermal cycling, which may comprise a first “denaturation” step (i.e. phase) in which the PCR sample volume (i.e. PCR mixture) is heated to a temperature of at least about 90 degrees Celsius up to about 98 degrees Celsius (or slightly higher temperatures), which causes double-stranded nucleic acid (DNA or RNA) within the PCR mixture (i.e. PCR sample volume) to melt apart by breaking the hydrogen bonds between complementary bases, yielding two single-stranded nucleic molecules. In some examples, denaturation temperature might exceed 100 degree Celsius for a short period of time for up to a few milliseconds, in some examples. A second step (i.e. phase) in the thermal cycling of a PCR assay test may comprise annealing in which less heat is applied to lower the reaction temperature to about 50-65° C., which allows annealing of the primers to each of the single-stranded nucleic acid templates as part of the reaction process. A third step (i.e. phase) of the thermal cycling of a PCR assay test may comprise elongation (i.e. extension) in which the heat applied to the PCR sample volume is selected to create a reaction temperature suitable for the particular nucleic acid (e.g. DNA) polymerase used. In some examples, one target activity temperature for a thermostable nucleic acid polymerase including Taq polymerase (e.g. a thermophilic eubacterial microorganism, Thermus aquaticus) is approximately 65-80° C. In this third step, the nucleic acid polymerase synthesizes a new nucleic acid strand complementary to the nucleic acid template strand by adding free nucleotide triphosphates (dNTPs) from the reaction mixture. In some examples, the different temperatures used in these three different temperature phases of thermal cycling may vary depending on the length of the nucleic acid strand, the time available, the type of target (e.g. RNA, DNA, etc.), the density of polymerase and primers, and/or other parameters.

Some types of implementing a PCR assay test may include combining the second and third phases (annealing and elongation) by heating the PCR sample mixture (after a denaturation phase) within a temperature range having values somewhere between the above-mentioned respective annealing and elongation temperature ranges to contemporaneously perform annealing and elongation.

In general terms, repetition of thermal cycles in performing the PCR assay test may result in an exponential increase in the quantity of the target nucleic acid sequence (e.g. DNA or RNA) to be amplified, which may sometimes be referred to the amplicon. Each cycle doubles the number of nucleic acid molecules (amplicons) amplified from the nucleic acid sequence template. For instance, in some implementations, repeating the PCR process for 30 cycles may produce on the order of 2³⁰ molecules of the target nucleic acid sequence. Of course, the number of cycles may vary depending on amplification efficiency, detection limit, or the analyte of interest, with some PCR processes utilizing thermal cycles between about 20 to about 40 cycles.

Once a sufficient number of cycles has been performed to obtain a desired quantity of the amplicons, the testing device hosting the PCR well(s) (or another testing device) may be used to detect the analyte of interest.

In some arrangements, optical detection may be used to detect output elements of the PCR assay test. This optical detection may be expressed as output element signal intensity, which may indicate a presence, a quantity, and/or a concentration of a particular analyte (e.g. virus particle, other) to which the output element is attached (e.g. bonded). In some arrangements, detection of the output elements also may be used to determine the progression of a PCR assay test.

In some arrangements, such optically-detectable output elements may comprise a fluorescent agent (e.g. dye), which may form part of the PCR master mix. One fluorescent agent may comprise a fluorophore which comprises a fluorescent chemical compound that can re-emit light upon light excitation. With this in mind, a PCR testing deice may comprise a wall or portion which permits the transmission of light into and/or through the PCR mixture within the testing device to enable optical detection of such fluorophores to determine a presence, quantity, and/or concentration of a particular analyte.

It will be understood that other methods may be used to detect a presence, quantity, and/or concentration of the target nucleic acid (e.g. DNA or RNA) sequence of interest after amplification by the PCR process.

With this general context in mind, in at least some examples of the present disclosure, an example method and/or example device is directed to exposing a droplet(s) to a multiple temperature phase heating process, which in some examples may comprise thermal cycling. In some such examples, the thermal cycling which may be used in nucleic acid amplification which may comprise a polymerase chain reaction (PCR) process, in some examples.

In some examples, the multiple temperature phase heating process may be performed with a plurality of droplets within a fluid passageway of on a digital microfluidic device including an electrode pad array having multiple zones which are independently heatable to selective temperatures, with the droplets movable within and between the different selectably heatable zones.

With this in mind, in some examples, a digital microfluidic device comprises an array of controllable electrode pads alignable with a fluid passageway and a control portion to cause electrowetting movement of a droplet within the fluid passageway through a circuit of multiple different zones of the electrode pads via iteratively: exposing the droplet within a current zone of the different zones for a selectable current time period at a current temperature of a list of consecutive temperatures: further exposing the droplet within the current zone, for each respective selectable subsequent time period, at each respective subsequent temperature of the list which is greater than the current temperature; and moving the droplet into a subsequent zone of the different zones when one of the respective subsequent temperatures is less than the current temperature.

Via such example arrangements, at least two temperature phases of a multiple temperature phase process may be performed within a single zone. For example, the droplet(s) may be exposed to an annealing temperature and following by exposure to a higher elongation temperature (different from the annealing temperature) within a single heating zone of electrode pads. This arrangement avoids the droplet(s) from being exposed to an ambient temperature such as if the droplet(s) were moved from an annealing zone (i.e. a zone in which solely annealing is performed) to an elongation zone (i.e. a zone in which solely elongation is performed) as might be found in some non-example arrangements. The example arrangement of the present disclosure also may avoid a relatively expensive and slower process, as might be the case if a device were to attempt using heat to maintain an entire microfluidic device (e.g. electrode control board) at at least an annealing temperature to prevent a droplet from dropping below an annealing temperature as the droplet moved from an annealing zone (i.e. a zone in which solely annealing is performed) to an elongation zone (i.e. a zone in which solely elongation is performed). In such situations, maintaining the entire microfluidic device (e.g. board) at single temperature may preclude simultaneous use of the rest of the microfluidic device (e.g. board) for other activities for which a lower temperature may be desired.

By performing at least two temperature phases of a multiple temperature phase process within a single zone, thermal cycling may be performed more rapidly because the droplet(s) is not moved between different heating zones for each and every different temperature phase as would be the case if a different heating zone were provided for each different temperature phase and just a single temperature phase were performed in each respective heating zone.

Via at least some examples of the present disclosure, a droplet(s) is moved from one heating zone in which the droplet was just exposed to a highest temperature (e.g. denaturation) of a multiple temperature phase process to a subsequent heating zone in which the droplet(s) is to be exposed to a lower temperature (e.g. annealing). Because this movement may be performed rapidly (e.g. fractions of a second), the overall testing may be performed quicker.

In sharp contrast, in some non-example arrangements in which a single zone is used to apply each temperature (of a multiple temperature phase process), a significant amount of time may pass (e.g. 3 seconds) from the end of the exposure of the droplet(s) of a highest temperature (e.g. denaturation) to exposure of the droplet(s) to a lower temperature (e.g. annealing), which results in a relatively slow test and also subjects the droplet(s) to the temperatures between the highest temperature (e.g. denaturation) and the lowest temperature (e.g. annealing), which may affect an accuracy or reliability of the testing.

In some of the example arrangements, multiple droplets within one heating zone may be simultaneously exposed within one temperature phase (of a multiple temperature phase process), with each multiple different temperature phase implemented for a selectable time period. Via this arrangement, a group of multiple droplets which travel together and are present within a given heating zone will have a matching thermal history, which may increase uniformity, reliability, and/or accuracy of the testing on a drop-to-drop basis. Moreover, to the extent that each droplet (within the group of multiple droplets) completes the same total number of thermal cycles as they travel along and within the same circuit of heatable zones, then all of the droplets of the group will experience identical thermal histories upon completion of the same number of thermal cycles (e.g. 20, in some examples). In sharp contrast, some non-example arrangements may transport droplets between zones, or move droplets in and out zones, in a train-like manner in which every droplet of the multiple droplets does not experience the same thermal history, which in turn may lead to variances in the nucleic acid amplification process, thereby reducing an accuracy of the testing results across multiple droplets.

In at least some examples of the present disclosure, each of the respective zones in which a droplet is exposed to a temperature (of the temperature list) may sometimes be referred to as a heating zone, each of which may be selectively heated independently of each other. In sharp contrast, some non-example arrangements may rely on heating an entire board including non-heating portions, which involves a much larger thermal mass, which in turn may consume significantly more time for cooling and/or heating.

In some examples, the droplet comprises a nucleic acid amplification mixture and the control portion is to cause the list of consecutive temperatures to comprise a first temperature and a second temperature, which exhibit a first substantial temperature difference. A respective one of the subsequent temperatures in the current zone which has a highest value of the respective temperatures of the list comprises the first temperature of a nucleic acid amplification process and is the last respective subsequent temperature in the current zone prior to the moving the droplet into the subsequent zone.

In some examples, wherein the list of consecutive temperatures corresponds to a sequence of temperatures for performing nucleic acid amplification, and wherein the control portion is to cause the list of consecutive temperatures to comprise three different temperatures including a first temperature; a second temperature, wherein the second temperature is a first substantial difference from, and less than, the first temperature; and a third temperature. The third temperature comprises a second substantial difference from, and is greater than, the second temperature, and wherein the third temperature comprises a third substantial difference from, and is less than the first temperature. A respective one of the subsequent temperatures of the list of consecutive temperatures which has a highest value comprises the first temperature.

In some examples, the control portion is to cause initiation of the iterations by omitting the further exposing when the current temperature in the current zone is the first temperature of the temperature list and there are no subsequent temperatures of the list which are greater than the current temperature. In some such examples, the first temperature may comprise a temperature at which a first temperature phase of a thermal cycle for nucleic acid amplification is performed, which in some examples, may comprise a temperature at which denaturation is performed in a polymerase chain reaction (PCR process). With this in mind, it will be understood that in some examples, the labeling of the respective different temperatures as being a first temperature, a second temperature, and a third temperature does not necessarily correspond an order in which the respective temperatures are implemented within a particular zone but rather may correspond to a sequence of temperatures of a nucleic acid amplification process such as, but not limited to, polymerase chain reaction (PCR) process.

In some examples, the multiple different zones comprise at least a pair of the respective different zones in which the respective temperatures of the list are applied, and a passive zone interposed between the pair of zones and through which the droplet is to move as the droplet travels between the pair of zones.

In some examples, the multiple different zones comprise a pair of outer zones and a common zone interposed between, and spaced apart from, the outer zones, wherein movement of the droplet occurs between a respective one of the outer zones and the common zone. A pair of passive zones with each respective passive zone is interposed between the common zone and a respective one of the outer zones.

In some examples, the control portion is to cause, at least during exposure of the droplet to a respective one of the current temperature and respective subsequent temperatures within the respective zones, shuttling the droplet among different electrode pads within a respective one of the zones in which the droplet is present.

In some examples, the droplet comprises a first droplet of a plurality of droplets, and the control portion is to cause the exposure of the first droplet to occur as simultaneous exposure of the plurality of droplet within the respective current zone and subsequent zone at the respective temperatures for the respective selectable time periods.

In some examples, the control portion is to cause maintaining separation of the first droplet from a second droplet of the plurality of droplets within the current zone during the exposing the plurality of droplets and during the moving of the droplets from the current zone to the subsequent zone.

In some examples, the control portion is to cause, via the shuttling movement of the droplet back and forth between adjacent electrode pads, the first droplet to become merged with and subsequently separated from a second droplet of plurality of droplets, wherein the second droplet comprises a liquid compatible with the liquid of the first droplet.

In some examples, a digital microfluidic device comprises a two-dimensional array of independently controllable electrode pads couplable to a consumable receptacle including a fluid passageway to receive a droplet, the fluid passageway defining a two-dimensional array of electrode locations corresponding to the two-dimensional array of electrodes; and a control portion to cause electrowetting movement of a droplet within the fluid passageway through a circuit of multiple different heating zones of the electrode pads via iteratively: exposing the droplet within a current heating zone of the different zones for a selectable current time period at a current temperature of a list of consecutive temperatures; further exposing the droplet within the current heating zone, for each respective selectable subsequent time period, at each respective subsequent temperature of the list which is greater than the current temperature; and moving the droplet into a subsequent heating zone of the different zones when one of the respective subsequent temperatures is less than the current temperature, wherein upon moving the droplet to the subsequent zone, the subsequent zone of circuit corresponds to a new current zone and the first respective subsequent temperature corresponds to a new current temperature.

In some such examples, the multiple different heating zones comprise a pair of outer heating zones and a common heating zone interposed between, and spaced apart from, the outer heating zones, wherein movement of the droplet occurs between a respective one of the outer heating zones and the common heating zone. A pair of passive zones with each respective passive zone interposed between the common heating zone and a respective one of the outer heating zones.

In some such examples, the control portion is to cause the exposure of a plurality of droplets, including the droplet, simultaneously within the respective current zone.

In some examples, a method comprises performing electrowetting movement of a droplet within a fluid passageway, aligned with an array of controllable electrode pads, through a circuit of multiple different zones of the electrode pads via repeating a sequence of: exposing the droplet within a current zone of the different zones for a selectable current time period at a current temperature of a list of consecutive temperatures; further exposing the droplet within the current zone, for each respective subsequent time period, at each respective subsequent temperature of the list which is greater than the current temperature, wherein the subsequent temperature becomes the current temperature in the current zone; and moving the droplet into a subsequent zone of the different zones when one of the respective subsequent temperatures is less than the current temperature in the current zone.

In some such examples, the method may further comprise, for each respective one of the multiple zones, the last predetermined temperature of the series is greater than a first predetermined temperature of the series of another respective one of the zones.

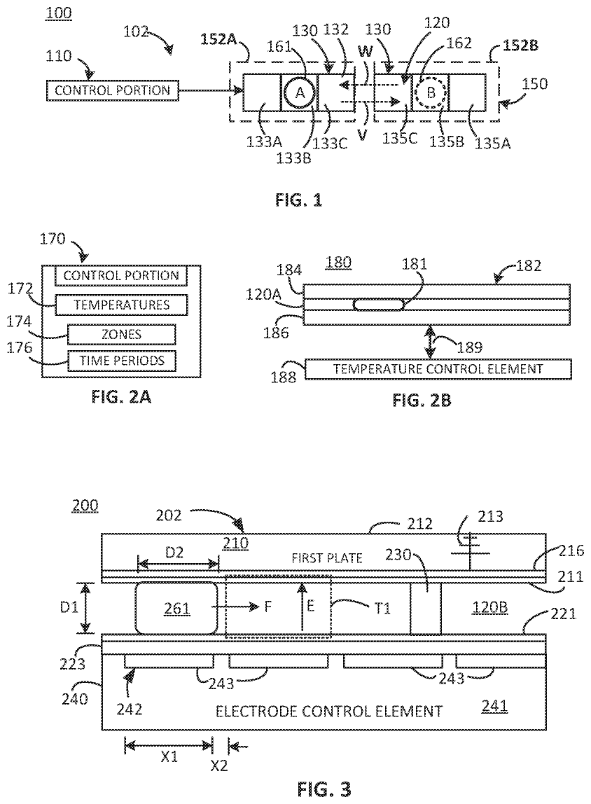

These examples and additional examples are further described below in association with at least FIGS. 1-12.

FIG. 1 is a diagram schematically representing an example arrangement 100 for implementing an example device (or example method) for performing a multiple temperature phase heating process such as for thermal cycling. As shown in FIG. 1, in some examples the example arrangement 100 comprises a digital microfluidic device 102 including an array 130 of controllable electrode pads 133A-133C, 135C-135A alignable with a fluid passageway 120 (FIG. 3) and a control portion 110 to cause electrowetting movement of a droplet 161 within the fluid passageway 120 through a circuit of multiple different zones 152A, 152B of the array 130 of electrode pads. It will be understood that in some examples, the zones 152A, 152B may comprise a greater number or lesser number of electrode pads (or electrode pad locations) than shown in FIG. 1. With this in mind, it will further understood that the example arrangement 100 may be considered representative of operation of a larger electrode pad array and larger microfluidic device.

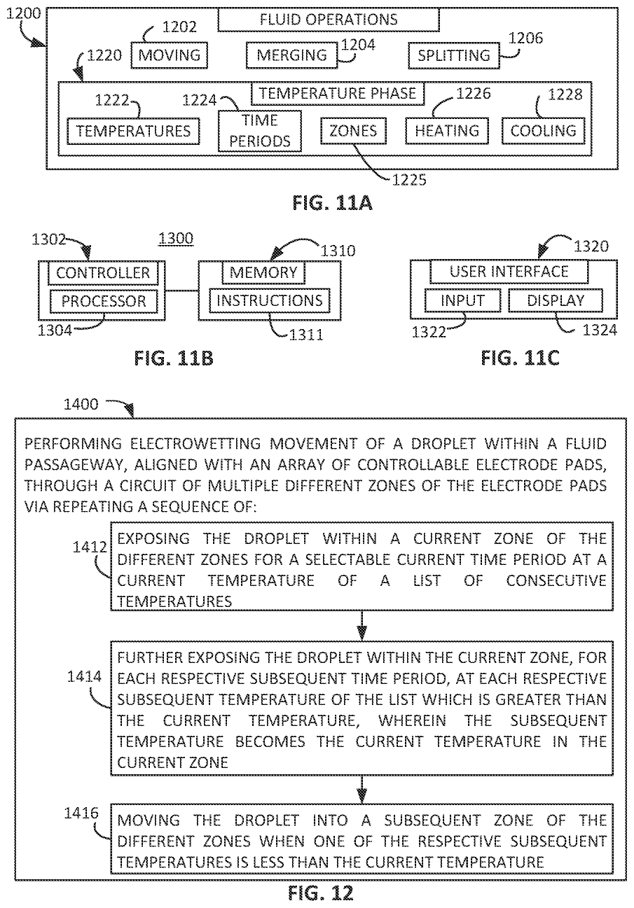

In some examples, the control portion 110 of FIGS. 1, 2A may comprise at least some of substantially the same features as, and/or an example implementation of, the examples of FIGS. 11A-11C associated with and/or including control portion 1300. In some such examples, at least a portion of the control portion 110 may be implemented within the microfluidic device 102, such as within (or attached to) structure defining a microfluidic receptacle 182 as described later in FIG. 2B, in some examples. As further described later in association with at least FIGS. 11A-11C, in some examples the control portion 110 may be separate from, but in communication with, the microfluidic device 102.

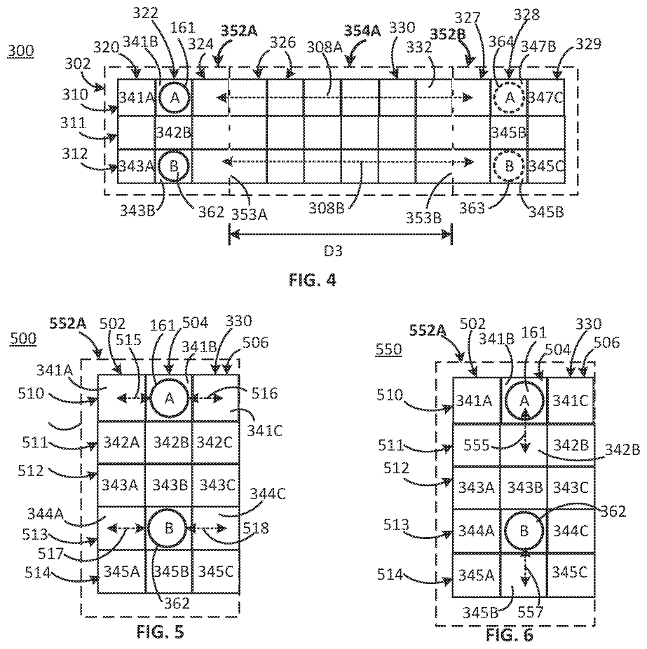

In some examples, and as later shown in FIGS. 4-9, the droplet 161 may comprise just one of a plurality of droplets present within the fluid passageway 120.

At least part of the example operation of the microfluidic device to perform thermal cycling comprises the control portion 110 causing electrowetting movement to iteratively: (1) expose the droplet 161 within a current zone (e.g. 152A) of the different zones (152A, 152B) for a selectable current time period at a current temperature of a list of consecutive temperatures; (2) further exposing the droplet 161 within the current zone (e.g. 152A), for each respective selectable subsequent time period, at each respective subsequent temperature of the list which is greater than the current temperature; and (3) moving the droplet into a subsequent zone (e.g. 152B) of the different zones (152A, 152B) when one of the respective subsequent temperatures is less than the current temperature.

It will be further understood that in some examples, the control portion 110 may cause further actions to precede or follow the above-described actions, as later described further below.

In general terms, in some examples each electrode pad (e.g. 133A-133C, 135A-135C) of the array 130 refers to a discrete location along or within the fluid passageway 120 associated with an individual controllable electrode, such that coordinated activation of the individual controllable electrodes by control portion 110 causes electrowetting movement of a droplet from electrode pad to electrode pad as desired, as further described later in association with FIG. 3.

In some examples, the array of independently controllable electrodes is permanently coupled or releasably coupled to a consumable microfluidic receptacle which includes the fluid passageway 120 to receive at least one droplet. The fluid passageway defines an array of electrode pad locations corresponding to the locations of the electrodes of the array. For example, as shown in FIG. 3, the respective electrodes may underlie the respective electrode locations of the fluid passageway. In this sense, in some examples an electrode pad may refer to both a location within or along the fluid passageway 120 and an operable electrode underlying that location.

With these aspects in mind, and as described with further reference to FIG. 1 and as further shown in FIG. 2A, the control portion 110 may cause tracking of, and/or control of, selectable temperatures (parameter 172) to which the droplet 161 is exposed within the respective zones (parameter 174) of the array of electrode pads for selectable time periods (parameter 176). In some examples, the temperatures, zones, and/or time periods may be maintained in various forms such as a list. Each list may be maintained independent from each other and/or the respective lists may be inferred from each other. In some examples, a list of a temperatures, zones, and/or time periods also can comprise or represent a subset (i.e., sublist) of a larger list of temperatures, zones, and/or time periods, with the entire list or subset of such lists being repeated as part of implementing thermocycling.

In some examples, a list of temperatures comprises a list of consecutive temperatures such as one temperature following after another temperature in a particular order (e.g., 90 degrees Celsius, 64 degrees Celsius, 80 degrees Celsius, in some examples) which is not necessarily an ascending or descending numerical order and/or which is not necessarily strict numerical ordering on a single integer-by-integer basis (e.g. 10 degrees Celsius, 11 degrees Celsius, 12 degrees Celsius).

In some examples, at least a portion of the list of consecutive temperatures comprises a sequence of temperatures used in implementing the temperature phases of a nucleic acid amplification process such as, but not limited to, polymerase chain reaction (PCR) process. Accordingly, in some such examples, one list of consecutive temperatures may comprise temperatures such as 90 degrees Celsius, 64 degrees Celsius, and 80 degrees Celsius, with other example temperatures and temperature ranges as described above and further described below.

As further described below, in some examples the sequence of temperatures (in the list of consecutive temperatures) may comprise two temperatures such as in a two temperature phase PCR process, such as when a first temperature used for denaturation (e.g., 90 degrees Celsius) and a second single temperature is used to implement both annealing and elongation (e.g. 64 degrees Celsius).

It will be understood that specific temperatures given in this specification are illustrative and specific examples may comprise temperatures different from those listed above to achieve the examples' goals. For example, an example temperature for performing denaturation may specify, e.g., 90 degrees Celsius, 92 degrees Celsius, 89.2 degrees Celsius, or any other temperature deemed appropriate for the function. It will also be understood that the specific temperatures are to be construed as target temperatures and may, in some examples, be considered to have been achieved if the actual temperature implemented via a temperature control element (e.g. 188 in FIG. 2B) is brought within some range (e.g., plus or minus 0.25 degrees Celsius) of the specified target temperature.

In some examples, the sequence of temperatures (in the list of consecutive temperatures) may comprise three temperatures such as in a three temperature phase PCR process including a first temperature phase (e.g. for denaturation), a second temperature phase (e.g. for annealing), and a third temperature phase (e.g. for elongation).

In some examples, the first temperature of the list of consecutive temperatures does not correspond to the first temperature which the droplet 161 experiences (e.g. is to be exposed to) within a zone (e.g. 152A, 152B) upon entry of the droplet 161 within a zone. Rather, in some such examples, the first temperature of the list of consecutive temperatures may comprise the last temperature to which a droplet 161 is exposed within a zone just prior to the droplet 161 moving to a subsequent zone.

One example implementation of a thermal cycling process (e.g. nucleic acid amplification) begins with the control portion 110 causing the current zone (e.g. 152A) to exhibit a first temperature (of the list of consecutive temperatures) and then exposing the droplet 161 to the first temperature for a selectable time period (e.g. 1 second). In some such examples, this action may comprise a first temperature phase of the nucleic acid amplification process.

In some examples, prior to the zone 152A reaching the first temperature, the droplet 161 may be temporarily held in an area or zone adjacent the zone 152A. In some such examples, the passive zone or adjacent area may be held at a selectable temperature, which may comprise a base temperature, which may be similar to annealing temperature (e.g. 64 degrees Celsius), or other temperature.

However, in some examples, the droplet 161 may be present within zone 152A for a brief period of time while zone 152A is at the base temperature prior to the zone 152A being heated to the first temperature, such as the denaturation temperature.

After completing exposure of the droplet 161 to the first temperature for the selectable time period, the control portion 110 implements electrowetting movement of droplet 161 from zone 152A to zone 152B, as represented via directional arrow V. In some such examples, this movement occurs when the temperature in zone 152B is lower than the first temperature in zone 152A. Upon arrival of droplet 161 in zone 152B, zone 152B is then referred to as the current zone and zone 152A becomes a subsequent zone, i.e., a zone to which the droplet 161 will be next be moved. The arrival and presence of the droplet 161 in zone 152B is represented via dashed lines 162 at location B (e.g., electrode pad 135B).

Further details regarding the transport of the droplet 161 from zone 152A to zone 152B are described later in association with at least FIGS. 4-8. At least one such detail includes an example manner of transport of the droplet 161 from zone 152A to zone 152B (or vice versa) occurring via a passive zone, i.e. non heating zone.

However, it may observed for purposes of discussion of the example arrangement of FIG. 1 that the droplet 161 is not actively heated during transport between zones 152A, 152B, and that the distance and time of transport are selected so that the temperature of the droplet 161 does not fall below a second temperature of the list of temperatures corresponding to a second temperature phase (e.g. annealing) of the nucleic acid amplification process. In one aspect, this attribute may prevent the annealing step from being irreproducible. In particular, because the target annealing temperature is about 3-5 degrees Celsius lower than a melting temperature of the primers used in a PCR mixture (in some examples), if the temperature of the droplet 161 were to fall below the target annealing temperature, unwanted hybridization may occur, thereby resulting in non-specific amplification, which in turn may retard the intended nucleic acid amplification process (e.g., PCR process).

With droplet 161 in zone 152B (e.g., at location B, electrode pad 135B), the control portion 110 implements the second temperature phase (e.g., annealing) for a selectable time period (e.g., 1 second). In some such examples, the annealing temperature may comprise about 64 degrees Celsius. In one aspect, this exposure may sometimes be referred to as an exposure of the droplet to a current temperature within a current zone. It will be understood that in some such examples, the “new” zone (e.g. zone 152B) into which the droplet 161 will be moved may be brought to the second temperature (e.g., target temperature) while the droplet 161 is being heated at the first temperature in the other zone (e.g. zone 152A) so that upon movement of droplet 161 from the first zone (e.g. 152A) to the next zone (e.g. 152B), the next zone already exhibits the target temperature prior to arrival of the droplet 161. Moreover, it will be understood that, in some examples, this type of pre-heating (to a target temperature) of the next zone to which a droplet will be moved may be implemented in and throughout the various examples of the present disclosure.

Next, with the droplet 161 remaining in zone 152B, the control portion 110 causes heating of zone 152B to reach the third temperature of the list of temperatures corresponding to a third temperature phase (e.g. elongation) of a nucleic acid amplification process, in some examples. The droplet 161 may be exposed to the third temperature for a selectable time period of about 3 seconds in some examples. In some such examples, the third temperature may comprise about 80 degrees Celsius. At the end of this selectable time period, one thermal cycle of the nucleic acid amplification process is completed.

With further reference to at least the foregoing examples, in some examples a first temperature in the list of consecutive temperatures (for performing thermal cycling) comprises at least about 90° Celsius, wherein the second temperature comprises at least about 18 degrees to about 32 degrees less than the first temperature, and the third temperature comprises at least about 5° C. greater than the second temperature and at least about 15° C. less than the first temperature.

Next, the control portion 110 causes further heating of the droplet 161 within zone 152B to reach the first temperature (e.g. a denaturation temperature) of the temperature list and once that temperature is reached, the droplet 161 is exposed to the first temperature for the selectable time period (e.g. 1 second). In one aspect, the first temperature (e.g. at least 90 degrees Celsius in some examples) is substantially greater than the second temperature (e.g. annealing temperature) of the temperature list.

In one aspect, the implementation of a first temperature phase within zone 152B, after implementing the third temperature (of the list of consecutive temperatures) may be considered the initiation of a next thermal cycle.

After the completing exposure of the droplet 161 to the first temperature within zone 152B, the droplet 161 is transported (e.g. arrow W) via electrowetting movement from zone 152B to zone 152A.

Similar to the transport from zone 152A to zone 152B, the transport from zone 152B to zone 152A is performed over a distance and for a time period during which the temperature of the droplet 161 is maintained no less than (i.e. does not drop below) at target limit, which may comprise the second temperature (e.g. annealing temperature). As further described later in association with at least FIGS. 4-8, the transport from zone 152B to zone 152A (or vice versa) may occur via a passive zone.

Upon its arrival in zone 152A, the droplet 161 is exposed to the second temperature (e.g. annealing) for a selectable time period (e.g. 1 second), and then with the droplet 161 remaining in zone 152A, the control portion 110 heats the zone 152A to the third temperature (e.g. elongation) and maintains the third temperature for a selectable time period (e.g. 3 seconds). This action completes the second thermal cycle.

The next thermal cycle begins with droplet 161 remaining in zone 152A and the control portion 110 causes rapid heating of zone 152A to reach the first temperature (e.g. denaturation) of the temperature list (e.g. multiple temperature phase process) and then maintaining exposure of the droplet to that first temperature for a selectable time period (e.g. 1 second). Accordingly, in a manner similar to the previous description regarding zone 152B, while in zone 152A the droplet 161 was first exposed to one temperature (e.g. second temperature for annealing) for a selected time period, further exposed to a third temperature for a selectable time period to complete a thermal cycle, and then exposed to first temperature (e.g. denaturation temperature) for a selected time period to begin a next thermal cycle.

As previously described, the droplet is then transported to the subsequent zone (e.g. zone 152B), where the droplet is exposed to one temperature (e.g. annealing) for a selected time period and then further exposed to a higher subsequent temperature (e.g. elongation) for a selected time period to complete the next thermal cycle.

Upon repeating this iterative process, a selectable number of thermal cycles may be completed.

With further reference to at least the foregoing examples, in some examples a first temperature in the list of consecutive temperatures (for performing thermal cycling) comprises at least about 90° Celsius, wherein the second temperature comprises at least about 18 degrees to about 32 degrees less than the first temperature, and the third temperature comprises at least about 5° C. greater than the second temperature and at least about 15° C. less than the first temperature.

In some examples, a two temperature phase nucleic acid amplification process may be performed in which the annealing and elongation are performed simultaneously at a single temperature. For example, with further reference to FIG. 1, with droplet 161 in a current zone 152A, the control portion 110 may begin an example method by exposing droplet 161 to a current temperature, as first temperature (e.g. a denaturation temperature) in a thermal cycle for selected time period. In some examples, the heating may be implemented at rate of about 100 degrees Celsius per second in order to quickly achieve the first temperature of the thermal cycle.

Thereafter, the control portion 110 causes transport of the droplet 161 to a subsequent zone 152B with droplet 161 cooling (e.g. passively) during transport to arrive in the subsequent zone 152B (at a speed over distance) where the droplet 161 does not cool below a second temperature such as an annealing temperature. In some examples, the cooling may occur at a rate of 10 degrees Celsius per second.

Prior to arrival of droplet 161 at zone 152B, the control portion 110 causes heating to cause the zone 152B to exhibit the second temperature at which both annealing and elongation may occur (such as, but not limited to, 64 degrees Celsius).

Upon its arrival in zone 152B, the droplet is exposed to the second temperature for a selectable time period, which completes a thermal cycle.

With droplet 161 remaining in zone 152B, control portion 110 causes heating of zone 152B to reach the first temperature (e.g. denaturation) and maintains exposure of the droplet 161 for a selectable time period (e.g. 1 second) to the first temperature.

Afterward, the droplet 161 is transported (arrow W) from zone 152B to zone 152A for a time and distance to permit droplet 161 to cool but without dropping below the target limit, e.g. a second temperature of the list.

Once within zone 152A, the droplet 161 is exposed to the second temperature at which both annealing and elongation may occur for a selectable time period (e.g. 3 seconds) to complete a thermal cycle again. Thereafter, a next thermal cycle is initiated via the control portion 110 again causing heating of the zone 152A to the first temperature of the list of consecutive temperatures in which the first temperature is the highest temperature of the list of consecutive temperatures.

This iterative process continuing until a selectable number (e.g., 20, 25, 30) of thermal cycles has been completed for the droplet 161.

As apparent from the foregoing description regarding FIG. 1, upon moving the droplet 161 from a current zone (e.g., 152A) to a subsequent zone (e.g., 152B), the subsequent zone (e.g., 152B) of the circuit corresponds to the new current zone (e.g., 152B) and the first respective subsequent temperature corresponds to the current temperature. In subsequent movements of the droplet, the droplet is moved from the current zone (e.g., 152B) to a subsequent zone (e.g., 152A), with this process repeating itself as a circuit.

As further shown in diagram 180 of the partial sectional side view of FIG. 2B, one example implementation includes microfluidic receptacle 182 and a temperature control element 188, both of which may be controlled via control portion 110 (e.g., FIGS. 1, 2A). In some examples, the microfluidic receptacle 182 comprises one example structure which defines fluid passageway 120A, like passageway 120 in FIG. 1.

As shown in FIG. 2B, the microfluidic receptacle 182 may comprise a first plate 184 spaced apart from a second plate 186, which together define the fluid passageway 120A (like 120 in FIG. 1) within which droplet 161 is moveable via selective application of an electrowetting forces via the array 130 of electrode pads (FIGS. 1, 3). As represented via arrow 189, the temperature control element 188 may comprise at least one heating element coupled relative to, and/or incorporated within, the microfluidic receptacle 182 to cause a selectable temperature to be exhibited within the fluid passageway 120, including droplet 161 when present.

In some examples, each zone 152A, 152B (FIG. 1) may comprise or be associated with its own temperature control element 188 such that the temperature of the fluid passageway 120 for each respective zone (e.g., 152A, 152B) may be independently controlled. In some such examples, the temperature control element 188 for a particular zone (e.g., 152A or 152B) may comprise a single heating element or may comprise multiple heating elements with each heating element affecting a different portion of the respective zone, but with the multiple heating elements treated as a single logical element to implement the same temperature for the entire respective zone.

In some examples, the temperature control element 188 may comprise a cooling element in addition to the heating element with the respective cooling and heating elements working in a cooperative or complementary manner to implement a selectable temperature of the fluid passageway 120 (and therefore droplet 161). In some examples, the temperature control element 188 may comprise a thermoelectric element including both heating and cooling effects such as, but not limited to, the Peltier effect. In some examples, the temperature control element 188 may comprise a heating element whose temperature is related to resistance, which may vary according to an applied voltage. In some examples, the temperature control element 188 may comprise, and/or be associated with, a heat sink to modulate the temperature of the fluid passageway 120 (and therefore of droplet 161). The heat sink may be used in a cooperative and/or complementary manner with a heating element and/or cooling element.

It will be understood that sensors may be located in various locations of the microfluidic receptacle 182 of FIG. 2B in order to provide feedback to help track and control target temperatures, rate of heating, rate of cooling, etc.

FIG. 3 is a diagram 200 which schematically represents a microfluidic device 202, which comprises one example implementation of the microfluidic devices of FIGS. 1, 2B and accordingly, the microfluidic device 202 comprises at least some of substantially the same features and attributes as examples of FIGS. 1-2B. As shown in FIG. 3, the microfluidic device 202 comprises a first plate 210 (like first plate 184 of FIG. 2B) and a second plate 220 (like second plate 186 of FIG. 2B) spaced apart from the first plate 210 to define fluid passageway 120B (like 120, 120A) within which droplet 261 (like droplet 161) may be selectively moved via electrowetting forces. In some examples, the first plate 210 may comprise an electrically non-conductive structure within which (or on) an electrically conductive element 216 may be located. In some examples, the first plate 210 may comprise a thickness of about 100 micrometers to about 3 millimeters, and may comprise a plastic or polymer material. In some examples, the first plate 210 may comprise a glass-coated, indium tin oxide (ITO). The electrically conductive element 216 may be connected to a ground element 213.

A hydrophobic coating 211, 221 may be located on (or define) an interior surface of each respective first and second plates 210, 220.

The second plate 220 may comprise an electrically non-conductive element 223 (e.g. a dielectric material) and an electrode control element 240 which comprises a substrate 241 supporting an array 242 of electrodes 243. The substrate 241 may comprise a dielectric material and also may house circuitry to support electrical activation of the electrodes 243, such as in coordination with control portion 110 (FIG. 1). Each electrode 243 corresponds to or comprises an electrode pad like (but not limited to) electrode pads 133A-133C, 135A-135C which are aligned with fluid passageway 120 to cause selective electrowetting movement of droplet 261 within the fluid passageway 120 such as along an array 130 of electrode pads 133A-133C, 135A-135C (FIG. 1). As shown in FIG. 3, the array 240 of electrode elements 243 acting as electrode pads (e.g. 133A-133C, 135A-135C) may be understood as underlying the fluid passageway 120.

It will be understood that the consumable microfluidic receptacle 202 may comprise spacer element(s) 230 at periodic or non-periodic locations between the first plate 210 and the second plate 240 to maintain the desired spacing between the respective plates 210, 240 and/or to provide structural integrity to the microfluidic receptacle 202 and second plate 240. The spacer elements 230 are positioned in a manner so as to not interfere with the movement of droplet 261 within and through the passageway 120B.

In some examples, at least the interior surface of the respective plates 210, 240 may comprise a planar or substantially planar surface. However, it will be understood that the passageway 120B defined between the respective first and second plates 210, 240 may comprise side walls, which are omitted for illustrative simplicity. The passageway 120B may sometimes be referred to as a conduit, cavity, and the like. With this in mind, the consumable microfluidic receptacle 202 may sometimes be referred to as a consumable microfluidic cavity.

In some examples, the interior of the passageway 120B (between plates 210, 240) may comprise a filler such as a dielectric oil, while in some examples, the filler may comprise air. In some such examples, the filler may comprise other liquids which are immiscible and/or which are electrically passive relative to the droplet 261 and/or relative to the respective plates 210, 240. In some examples, the filler may affect the pulling forces (F), may resist droplet evaporation, and/or facilitate sliding of the droplet and maintaining droplet integrity.

In some examples, the distance (D3) between the respective plates 210, 240 may comprise between about 50 micrometers to about 1000 micrometers, between about 100 to about 500 micrometers, or about 200 micrometers. In some examples, the droplet 130 may comprise a volume of between about 10 picoliters and about 30 microliters. However, it will be understood that in some examples, the consumable microfluidic device 202 is not strictly limited to such example volumes or dimensions.

In some examples, as shown in FIG. 3, each electrode 243 may comprise a length (X1) which may comprise a length expected to be approximately the same size as the droplet 130 to be moved. In view of the example volumes of droplets noted above, the length (X1) of each electrode 243 may comprise between about 50 micrometers to about 5 millimeters, and may comprise a width similar to its length in some examples. In some examples, as shown in FIG. 3, the length (X1) of each electrode 243 is generally commensurate with the length (D2) of a droplet or target position (e.g. T1) of a droplet within the consumable microfluidic receptacle 202. In some examples, the electrodes 243 may be spaced apart from each other by a distance X2.

In some examples, as further shown in FIG. 3, an electric field E which acts to induce electrowetting movement of droplet 261 acting within the passageway 120B may comprise an area (e.g., x-y dimensions) which are similar to the area (e.g. x-y dimensions) of each respective electrode 253.

In some examples, the array of electrode pads in FIG. 1, and as represented by electrodes 243 in FIG. 3, may extend in a two-dimensional array, such as in both an x direction and a y direction, such as later shown in FIGS. 4-9.

FIG. 4 is a diagram 300 including a top view schematically representing an example arrangement for an example device and/or example method of thermal cycling and which comprises a microfluidic device 302. The microfluidic device 302 comprises an array 330 of electrode pads 332, with it being understood that additional designators (e.g., 341A, 341B, and the like) may be used to indicate the particular location of a given electrode pad of the array 330 within and/or relative to various zones of the microfluidic device 302, as further described below. In some examples, the example arrangement 300 may comprise at least some of substantially the same features and attributes as, and/or an example implementation of, the example arrangements (e.g., example devices and/or example methods) of FIGS. 1-3, such as comprising multiple different zones 352A, 352B in which temperatures of a multiple temperature phase process may be applied. In some examples, the example microfluidic device 302 comprises a passive zone 354A interposed between the pair of zones 352A, 352B and through which droplet(s) 161, 362 are to move as the droplet(s) 161, 362 is transported between the pair of zones 352A, 352B. The dashed lines 353A, 353B represent opposite ends of the passive zone 354A.

In some examples, movement through a passive zone 354A occurs after droplet 161 has been last exposed to a first temperature of a thermal cycle (e.g. highest temperature of the cycle), with passive zone 354A sized (having a length, such as a number of electrode pads) and speed of droplet movement so that the temperature of droplet 161 is maintained above the “second temperature” (e.g. annealing temperature) which will be present in the zone to which the droplet is moved, in a manner similar to that previously described.

In some examples, the passive zone 354A is a non-heating zone, in which no heating is applied to a droplet. In some examples, the passive zone 354A has no capability of applying heat (e.g., via temperature control element 188), while in some examples, the passive zone 354A may comprise the ability to be heated (or cooled), but the control portion 110 selectively does not apply heat (or cooling) within the passive zone in order to achieve the desired temperature within the passive zone 354A.

In general terms, the passive zone 354A comprises a number of columns 326 between the respective zones 352A, 352B so that the distance D2 between the respective zones 352A, 352B permits a target amount of decrease in temperature the droplet 161 during transport (as represented by dashed arrows 310, 311) between the respective zones 352A for a given velocity of electrowetting movement of the droplet 161 from electrode pad to electrode pad. While the velocity of electrowetting movement can be controlled within a range, this velocity parameter is to be selected and implemented in cooperation with (e.g., in a complementary manner with) the distance D3, which is related to the number of columns 326 of electrode pads in passive zone 354A.

The passive zone 354A may comprise a greater number or a lesser number of columns 326 (between the respective zones 352A, 352B) than shown in FIG. 4, with the passive zone 354A having the number of rows 310, 311, 312 as zones 352A, 352B. However, in some examples, a number of rows (e.g., 310, 311, 312) for each zone 352A, 352B may be selected to accommodate a target number of multiple droplets simultaneously within each zone 352A, 352B.

While FIG. 4 represents one example movement of droplets through passive zone 354A (e.g., such droplets 161, 362 moving horizontally within rows), it will be understood that in some examples a passive zone may be arranged for vertical movement of droplets between respective heating zones such that droplets 161, 362 would move within columns between respective heating zones.

It will be understood that in some examples, the example microfluidic device 102 of FIG. 1 may comprise such a passive zone like zone 354A (FIG. 4) interposed between zones 152A, 152B (FIG. 1).

It will be understood that in some examples the example array 330 of electrode pads 332 may comprise a subset of a larger array of electrode pads which at least partially surround the array 330, with at least some electrode pads of the larger array of electrode pads being used to transport droplets into and/or out of the array 330 of electrode pads 332 of microfluidic device 302. In some examples, the droplets 161, 363 may enter the array 330 at electrode pad 341A or 343A, or may enter at another location, which is adjacent electrode pad 347C, 345C.

It will be further understood that in some examples a thermal cycling process can be selected to begin with droplet 161 in other positions such as, but not limited to, electrode pad 347B, 345B or other electrode pads of the array 330.

Like the example of FIG. 1, one example implementation of a multiple temperature phase process may begin with the control portion 110 causing heating of zone 352A (e.g. current zone) to a first temperature (e.g. denaturation) of a thermal cycle. The heating may begin from an ambient temperature or a base temperature greater than the ambient temperature.

Upon implementing the first temperature within zone 352A, the control portion 110 moves droplets 161, 362 into zone 352A to be exposed to the first temperature for a selectable time period (e.g. 1 second).

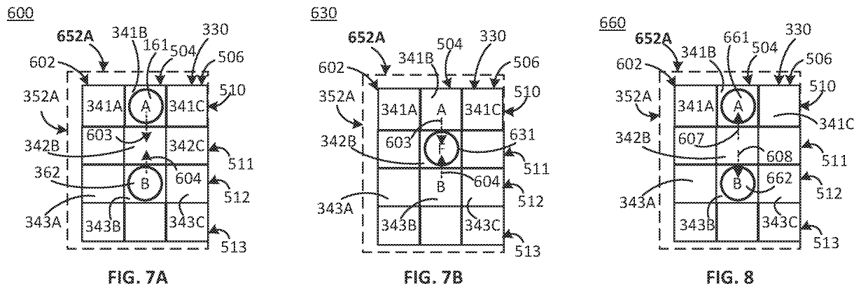

As further described later in association with at least FIGS. 5-6 and/or FIGS. 7A-8, during the presence of droplets 161, 362 within either zone 352A, 352B and at least during exposure to the respective first, second, and third temperatures, the control portion 110 may cause shuttling movement of the droplet 161, 362 within the zone 352A.

After exposure of the droplets 161, 362 to first temperature is completed, droplets 161, 362 are transported from zone 352A to zone 352B via passive zone 354A, as represented via arrows 308A, 308B. As droplets 161, 362 are transported through the passive zone 354A, the droplets 161, 362 cool from the first temperature to a temperature not less than a target limit before entering zone 352B. In some examples, the target limit may comprise a second temperature such as, but not limited to, an annealing temperature as previously described. In some examples, the cooling rate may be about 10 degrees Celsius per second.

As with FIGS. 1-3, prior to arrival of droplets 161, 362 in zone 352B, control portion 110 causes heating of zone 352B to exhibit a second temperature of the thermal cycle such that once droplets 161, 362 arrive at zone 352B, the droplets may be immediately exposed for a selectable time period (e.g. 1 second) to the second temperature of the temperature list (e.g. second temperature phase of a thermal cycle).

Thereafter, with droplets 161, 362 remaining in zone 352B, the control portion 110 causes further heating within zone 352B to reach a third temperature (e.g. 80 degrees Celsius) of the list such as a third temperature phase (e.g. elongation) of a thermal cycle. Upon reaching the third temperature, the droplets 161, 362 remaining in zone 352B are exposed within zone 352B to the third temperature for a selectable time period (e.g. 3 seconds).

This action completes one thermal cycle for droplets 161, 362. To begin the next thermal cycle, the control portion 110 causes further heating of zone 352B to exhibit the first temperature of the temperature list such that the droplets 161, 362 (which have remained in zone 352B) are exposed to the first temperature for a selectable time period (e.g. 1 second).

Next, the droplets 161, 362 are transported (as represented by arrow 308A, 308B) via passive zone 354A from zone 352B to zone 352A with droplets 161, 362 cooling along the way, but without dropping below the target limit, as previously described.

Prior to arrival of droplets 161, 362 at zone 352A, the control portion 110 causes zone 352A to exhibit the second temperature of the temperature list such that upon their arrival at zone 352A, the droplets 161, 362 can immediately begin exposure to the second temperature for the selectable time period.

Thereafter, the control portion 110 causes heating of the zone 352A to raise the temperature to the third temperature (e.g. elongation) of the temperature list, after which the droplets 161, 362 are exposed to the third temperature for the selectable time period (e.g. 3 seconds). At the conclusion of this exposure to the third temperature, a second thermal cycle for droplets 161, 362 has been completed.

In some examples, at least during the heating of the droplets 161, 362 within a particular zone (e.g. 352A), such zone 352A may sometimes be referred to as an active zone, while the other zone (e.g. 352B) may sometimes be referred to as a cooling zone or non-active zone.

This same process may be continued with the droplets 161, 362 moving through the circuit of the zones 352A, 354A, 352B until a selectable number of thermal cycles has been completed.

As evident from the foregoing example of FIG. 4, while present within zone 352A, the droplets 161, 362 may be exposed (sequentially) to different temperatures within at least a portion of temperature list of consecutive temperatures as part of implementing a thermal cycle for the droplets 161, 362. Similarly, while present within zone 352B, the droplets 161, 362 are exposed (sequentially) to different temperatures within at least a portion of a temperature list of consecutive temperatures as part of implementing a thermal cycle for the droplets 161, 362. As further apparent from the foregoing description of FIG. 4, when droplets 161, 362 are present within zone 352A, one temperature phase (e.g. the first temperature) of a thermal cycle is implemented and then when droplets 161, 362 are present within zone 352B, at least one other temperature phase (e.g. the second and third temperatures) of the same thermal cycle is implemented. Via this arrangement, part of thermal cycle is performed in one zone and then the remaining part of that thermal cycle are performed in another zone.

With further reference to FIG. 4, in some examples multiple droplets within one zone (e.g. 352A or 352B) may be simultaneously exposed to the same temperature of multiple different temperatures, with each multiple different temperature implemented for a selectable time period.

Via this arrangement, a group of multiple droplets which travel together and are present within a given zone (e.g. 352A or 352B) will have a matching thermal history Moreover, to the extent that the group of multiple droplets each complete the same total number of thermal cycles as they travel along and within the same circuit including the zones 352A, 352B, then all of the droplets of the group will experience identical thermal histories upon completion of the same number of thermal cycles (e.g. 20, in some examples).

As further evident from FIG. 4 and as later described in association with FIGS. 5-6, the multiple droplets with a zone (e.g., zone 352A) may be simultaneously exposed to a respective temperature (within a multiple temperature phase process) while remaining isolated from each other, such as having at least one empty electrode pad interposed between the multiple electrode pads.

Each of FIGS. 5-6 include a diagram 500, 550 (respectively) including a top view schematically representing a portion of an example microfluidic device 502 (and/or example method) corresponding to a heating zone 552A, similar to a portion of microfluidic device corresponding to heating zone 352A as shown in FIG. 4.

As shown in FIGS. 5-6, in some examples the portion of the microfluidic device 502 corresponding to zone 552A may comprise an array 330 of electrode pads 341A-341C, 342A-342C, 343A-342C, 344A-344C, and 345A-345C, which are arranged in rows 510, 511, 512, 513, 514 and columns 502, 504, 506.

As shown in FIG. 5, while present within zone 352A in some examples the control portion 110 causes droplet 161 to move between and among electrode pads 341A, 341B, 341C (within row 510) at least during exposure to one of the temperatures of the temperature list (a portion of a thermal cycle). It will be understood that during such movement, at any given time, the droplet 161 generally is located within or over one of the electrode pads 341A, 341B, 341C within row 510 and the other respective electrode pads 341, 341B, 341C remain unoccupied by any other droplet. This movement of the droplet 161 (or droplets) in different directions within row 510 as represented by directional arrows 515, 516 (e.g. left and right in some examples) may sometimes be referred to as shuttling or shuttling movement. In some examples, the movement illustrated in FIG. 5 may be considered as shuttling within or along a row (e.g. 510) of electrode pads, assuming a particular orientation of the array of electrode pads. In particular, assuming that in some examples the electrode pad 341B in column 504 is a starting position, the droplet 161 can be moved to the left (arrow 515) into column 502 over electrode pad 341A or can be moved to the right (arrow 516) into column 506 over electrode pad 341C, and then henceforth further moved within row 510 among columns 502, 504, 506 for a specified time period, such as during an exposure of the droplet 161 to one of the temperatures of the temperature list for a selectable time period, such as at least during a temperature phase of a thermal cycle.

Such shuttling, at least during a thermal cycle which includes heating within a particular zone (e.g., 352A), may enhance nucleic acid amplification (or other purposes). In particular, the droplets may be heated from the bottom, such as via temperature control element 188 (FIG. 2B) in some examples, such that the temperature at the bottom of the droplet may be higher than the temperature on the top of the droplet. By moving the droplet (e.g., 161) in a manner which changes its direction, such as shuttling, the movement introduce vortices in the liquid of the droplet, which in turn may result in a more uniform temperature field within the droplet.

Among other aspects, during such shuttling, droplet 161 remains isolated from droplet 362, such that droplets 161 and 362 are not mixed together. It will be understood that droplet 362 generally also is moved via shuttling between and among electrode pads 344A, 344B, 344C, in a manner substantially similar to the shuttling of droplet 161, although with droplet 362 in its own row 513 independent of movement of droplet 161 in row 510.

In some examples, shuttling is performed the entire time a droplet is within a respective one of the first and second zones 352A, 352B. In some examples, the shuttling is performed during, and between, each exposure to a respective one of the different temperatures within a respective one of the first and second heating zones (e.g., 352A, 352B in FIG. 4).

With further reference to the examples of FIGS. 5-6, in some examples, all of the droplets may be similar to each other, i.e. like droplets. However, in some examples, some or all of the droplets are unlike other respective droplets within a zone (e.g. 352A) such that at least some of the droplets comprise different reagent mixes from other droplets. Despite these differences, the droplets having different reagent mixes may still be thermocycled simultaneously by maintaining their isolation from each other, even during shuttling along and within a respective row (e.g., 510, 513) as represented in FIG. 5.

FIG. 6 is a diagram 550 like diagram 500, except schematically representing shuttling of droplets 161, 362 within a column (e.g., 504) between different rows (e.g., 510 and 511, and e.g., 513 and 514) of a subset of an array of electrode pads within a heatable zone 552A (like 352A or 352B). This type of “vertical” shuttling also may be performed in columns 502 and/or 506 in addition to, or instead of, in column 504. In some examples, the type of shuttling represented in FIG. 6 may comprise at least some of substantially the same features and attributes as in FIG. 5, except for the shuttling occurring within a column 504 (or columns 502, 506) instead of within a row (e.g., 510 or 513).

In examples in which it is desired to maintain isolation of different droplets 161, 362 from each other during such shuttling, then control portion 110 will cause the different droplets 161, 362 to move simultaneously, in the same direction, into an adjacent row. For instance, at the same time that droplet 161 is moved from row 510 into row 511, then droplet 362 is simultaneously being moved from row 513 into row 514. In a next movement, droplet 161 is moved from row 511 into row 510 with simultaneous movement of droplet 362 from row 514 into row 513. This simultaneous movement may sometimes be referred to as the droplets marching together in unison, while still maintaining their isolation from each other. A selectable number of iterations of this shuttling movement may be performed, such as least during exposure to the at least some of the different temperature phases of a thermal cycle as applied via (and within) zone 552A.

As further shown in at least FIG. 6, in some such examples of shuttling the control portion 110 will cause at least two rows (e.g., 511, 512) of electrode pads to be interposed between adjacent droplets 161, 362 prior to initiation of the shuttling to ensure that the respective droplets 161, 362 can be maintained independent of each other during such shuttling without nearby electrode pads otherwise causing inadvertent or partial mixing.

As previously noted elsewhere herein, it will be understood that zone 552A may be representative of larger zones having a larger array of electrode pads, having more droplets, and/or of multiple similar zones which may be the same size or different size as zone 552A (e.g., number of electrode pads).

In some examples, the control portion 110 may implement both types of shuttling shown in the respective FIGS. 5 and 6, such as in an alternating manner or other sequence in which at least some of the shuttling occurs in rows and at least some of the shuttling occurs in columns in a coordinated manner.

FIGS. 7A-8 is a series of diagrams, each including a top view schematically representing an example portion of a microfluidic device 602 (and/or example method) corresponding to a heating zone 652A (like zone 552A or 352A) and including an array 330 of controllable electrode pads as in the previously described examples. In some examples, the microfluidic device 602 may comprise at least some of substantially the same features and attributes as the examples of FIGS. 5-6 (and preceding FIGS. 1-4), except with the shuttling movement causing mixing of droplets 161 and 362 instead of maintaining their isolation as in FIGS. 5-6.

As shown in FIG. 7A, in some examples droplet 161 may start at a position within a row (e.g., 510) which is isolated from droplet 362 which may be in a row (e.g., 512) spaced apart from row 510. Upon initiation of a shuttling movement, the control portion 110 causes droplet 161 to move (as represented by arrow 603) via electrowetting forces from electrode pad 341B in row 510 to electrode pad 342B in row 511 simultaneously with droplet 362 being moved from electrode pad 343B in row 512 to the same electrode pad 342B in row 511 (as represented by arrow 604) as droplet 161 such that the droplets 161, 362 become merged together as a single droplet 631 (also represented as F), as shown in FIG. 7B. As an example, to merge two droplets 161, 362, the pad 342B to which the droplets 161, 362 are to moved is turned on, and the opposite adjacent pads 341B, 343B are turned off, thereby causing electrowetting forces to acting in opposite directions toward each other, as represented by arrows 603, 604.

As further represented in FIG. 7B, after a brief selectable time period, the control portion 110 causes electrowetting movement to split the merged droplet 631 into two separate droplets 661 and 662 which are moved apart from each other (as represented by arrows 607, 608) back to spaced apart rows 510, 512, as shown in FIG. 8. As an example, to split a droplet the pad 342B on which the droplet 631 sits is turned off, and the opposite adjacent pads 341B, 343B (FIG. 8) are turned on, thereby causing electrowetting forces act in opposite directions away from each other, as represented by arrows 607, 608.

This process of merging (FIGS. 7A-7B) and splitting the droplets (FIG. 8) may be repeated in a cyclical manner for a selectable time period, such as at least during exposure of the droplets 161, 362 within zone 652A to any one of the selectable temperatures of a temperature list, such as any one or all of the temperature phase of a thermal cycle. During such shuttling movement, the respective droplets are moved back and forth among a group of rows, such as rows 510, 511, 512. However, it will be understood that such shuttling to cause mixing is not necessarily limited to the number of rows shown in the example of FIGS. 7A-8.

Among other aspects, the mixing of droplets via such merging and splitting (as described with respect to FIGS. 7A-8) may cause disruption of the surfaces of the droplets 161, 362, which in turn may create even stronger vortices of the liquid (as compared to non-mixing shuttling movement) within the newly merged droplets (e.g. 631) or droplets 661, 662 from a recent split (FIG. 8). These stronger vortices may result in a more uniform temperature distribution within each droplet (e.g. 631, 661, 662), which may enhance the target effect within the droplets such as a phase of thermal cycling for nucleic acid amplification or for other purposes.

In some examples, droplet 161 (FIG. 7A) may comprise a liquid compatible with the liquid of the other droplet 362. In some such examples, the liquid may comprise a particular reagent mix used in preparing for, and/or, during nucleic acid amplification. In some such examples, multiple compatible droplets may be processed, including mixing with one another and being thermocycled through the same sequences of temperatures (in parallel in some examples), so that later they may be combined together to form a larger volume of liquid, which may be further processed for desired purposes instead of relying solely on droplet sized volumes.

However, in some examples, such mixing (via cycles of merging and splitting) may be used to mix droplets which initially include different components, which after being mixed may be used in further actions or processes on the electrode pad array.

In some examples, this mixing-type of shuttling is performed the entire time a droplet is within a respective one of the first and second zones (e.g. 352A, 352B in FIG. 4). In some examples, the shuttling is performed during, and between, each exposure to a respective one of the different temperatures within a respective one of the first and second zones.

Of course, in some examples in which such mixing of droplets is not desired, then the mixing-type of shuttling movement represented in FIGS. 7A-8 may be omitted.

While the examples of FIGS. 5-6, 7A-8 refer to particular types of shuttling movement such as merging and splitting in FIGS. 7A-8 which is shown occurring within a column as the droplets move back and forth among adjacent rows, it will be understood that the same type of shuttling movement to merge and split droplets may occur within a row as the droplets move back and forth among adjacent columns.

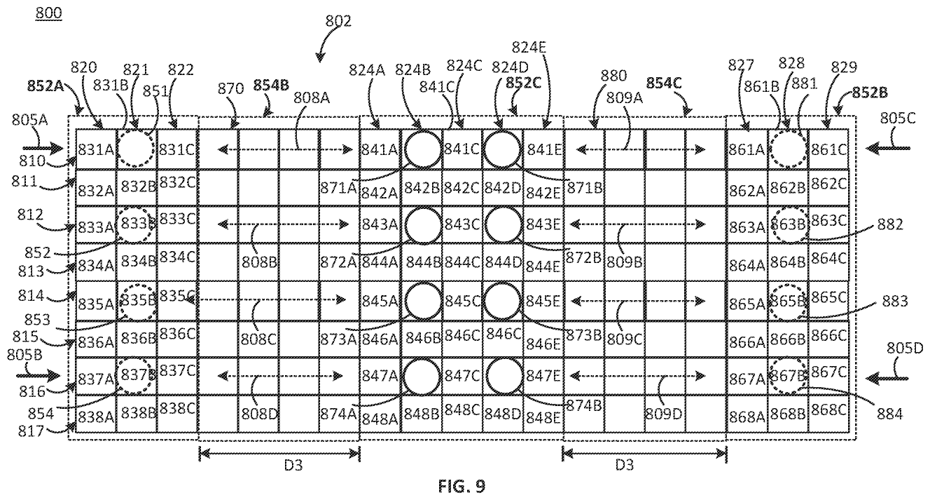

FIG. 9 is a diagram 800 schematically representing a portion of a microfluidic device 802 for fluid operations for thermal cycling, nucleic acid amplification, etc. In some examples, the portion of microfluidic device 802 comprises at least some of substantially the same features and attributes as the example microfluidic devices (and example methods), as previously described in association with at least FIGS. 1-8, such as including an array 330 of electrode pads arranged in rows 810-817 and columns 820-822, 870, 824A-824E, 880, 827-829, as further described below.

As shown in FIG. 9, the microfluidic device 802 comprises three heatable zones 852A, 852B, and 852C, each of which comprise features and attributes like the zones 352A, 352B in FIG. 4 (and/or FIGS. 5-8) and additional aspects as further described below. The heatable zones may sometimes be referred to as heating zones. With this arrangement, the heating zone 852C may sometimes be referred to as a common zone or middle zone. The common zone 852C is interposed between, and spaced apart from, the two outer heating zones 852A, 852B. Common zone 852C may comprise columns 824A, 824B, 824C, 824D, 824E of electrode pads 841A-848A, 841B-848B, 841C-848C, 841D-848D, 841E-848E, respectively. Meanwhile, outer zone 852A may comprise columns 820, 821, 822 of electrode pads 831A-838A, 831B-838B, and 831C-838C, respectively, while outer zone 852B may comprise columns 827, 828, 829 of electrode pads 861A-868A, 861B-868B, and 861C-868C. As with other examples throughout the present disclosure, in some examples a given heating zone or passive zone may comprise a greater number or lesser number of rows and columns than shown in FIG. 9 depending on the particular purposes for which the respective heating zones and passive zones are being employed.

In addition, the portion of the microfluidic device 802 comprises a pair of passive zones 854B, 854C (e.g., non-heating zones), each like passive zone 354A in FIG. 4. As shown in FIG. 9, one passive zone 854B is interposed between the two heating zones 852A, 852C, and the other passive zone 854C is interposed between the two heating zones 852C and 852B. Accordingly, each respective passive zone 854B, 854C is interposed between the common zone 852C and a respective one of the outer zones 852A, 852B. In some examples, passive zone 854B comprises a plurality of columns 870 (e.g., 5 columns in this example) and passive zone comprises a plurality of columns 880 (e.g., 5 columns in this example). Each passive zone 854B may comprise a plurality of rows 810-817, which are the same rows as those forming heatable zones 852A, 852B, 852C.

As shown in FIG. 9, in some examples the middle heating zone 852C is wide enough (i.e., has enough columns) to simultaneously host multiple independent columns of droplets 871A-874A, 871B-874B if desired but also may host just one column of droplets if desired.

Moreover, each of the respective heating zones 852A, 852B, 852C and passive zones 854A, 854C are not strictly limited to the numbers of columns and rows shown in the example of FIG. 9, such that in some other examples, such zones may have a greater number or lesser number of columns and rows.

In one example of operation to perform thermal cycling, the control portion 110 begins heating the middle zone 852C to a first temperature (e.g., denaturation) of a list of consecutive temperatures and the outer zones are heated to a second temperature (e.g. annealing) of the temperature list.

When the middle zone 852C has reached the first temperature and is maintained at that temperature, the droplets 871A-874A, 871B-874B are moved into middle zone 852C from an external location of adjacent electrode pads or from one of the passive zones 854B, 854C and kept within the zone 852C at the first temperature for a selectable time period, such as one second. In some examples, the control portion 110 may cause shuttling of droplets 871-874 positioned within the common zone 852C, such as in FIGS. 5-6 and/or FIGS. 7A-8. Accordingly, during such shuttling, the droplets 871A-874A from one column of droplets may be merged with, or be maintained independently from, droplets 871B-874B of another column of droplets depending on the particular goals to be achieved, with the control portion 110 using electrowetting movement to place and move the respective droplets among the respective electrode pads (e.g., 841A-841E, 842A-842E, 843A-843E, 844A-844E, 845A-845E, 846A-846E, 847A-847E, 848A-848E) as desired.

After the droplets 871A-874A, 871B-874B have been maintained within the middle heating zone 852C at the first temperature for the selectable time period, the droplets 871A-874A are moved together in parallel in their spaced apart relationship (e.g. in a lock step manner) out of the middle zone 852C and through the passive zone 854B along transport paths 808A-808D to outer zone 852A simultaneously with the droplets 871B-874B being moved together in parallel in their spaced apart relationship (e.g. in a lock step manner) out of the middle zone 852C and through the passive zone 854C along transport paths 809A-809D to outer zone 852B.

It will be understood that in examples in which a single column of droplets (e.g., just one column of droplets 871A-874A or column of droplets 871B-874B) is present within common zone 852C, the droplets may be split apart with a portion of each droplet heading in opposite directions toward the outside heating zones 852A, 852B. This splitting may be similar to the splitting shown in FIG. 8, except in a different direction.

Upon the exit of the droplets (e.g., 871A-874A, and 871B-874B) from the common zone 852C, the control portion 110 controls (e.g., adjusts) the application of heat to the common zone 852C to permit a temperature of the common zone 852C to decrease to, but not drop below, a second temperature such as an annealing temperature. At this stage, the common zone 852C may sometimes be referred to as a cooling zone or rest zone, at least in the sense in the absence of droplets, no active heating is being implemented for a period of time.

Meanwhile, via the application of heat, the control portion 110 has caused the outer zones 852A, 852B to exhibit the second temperature (e.g. an annealing temperature), such that the droplets (e.g., 871A-874A to zone 852A, e.g., 871B-874B to zone 852B) which have together simultaneously exited the common zone 852C arrive at the outer zones 852A, 852 to be simultaneously exposed to the second temperature for a selectable time period. Circular dashed lines 851-854, 881-884 represent the droplets after their arrival in the respective zones 852A, 852B. In some examples, the control portion 110 may cause shuttling of droplets positioned within the outer zones 852A, 852B, such as in FIGS. 5-6 and/or FIGS. 7A-8.

As noted elsewhere herein, by moving the droplets 871A-874A, 871B-874B in lockstep (e.g. in parallel simultaneously) from common zone 852C into the next heating zone such as the outer zones 852A, 852C, the droplets 871A-874A, 871B-874B will experience an identical thermal history, as compared to moving droplets in a train-like manner as may occur in some non-example devices.

Upon completion of exposure at the second temperature (e.g. annealing) for the selectable time period (e.g. one second), the control portion 110 causes further heating of the outer zones 852A, 852B to a third temperature (e.g. 80 degrees Celsius, such as for elongation) and once that temperature is achieved, the droplets are exposed to that temperature for a selectable time period (e.g. 3 seconds). In some examples, the droplets may continue shuttling as previously mentioned.

Upon completion of exposure at the third temperature (e.g., elongation) for the selectable time period, the droplets have completed a thermal cycle. With the respective droplets still remaining within the respective outer zones 852A, 852B, the next thermal cycle may begin immediately via the control portion 110 causing further heating of the outer zones 852A, 852B to a first temperature (as previously described for zone 852C) and once that first temperature is achieved, the droplets within outer zones 852A, 852B are exposed to that first temperature for a selectable time period (e.g., 1 second). In some examples, the droplets may continue shuttling as previously mentioned. This completes a first temperature phase of this present thermal cycle.

Upon completion of exposure within the outer zones 852A, 852B at the first temperature (e.g., denaturation) for the selectable time period, the droplets are transported via passive zones 854B, 854C (along transport paths 808A-808D, 809A-809D, respectively) back to the common zone 852C. In one aspect, at this stage the outer zones 852A, 852B may now be considered as cooling zones, e.g., temporarily inactive zones, and such that control portion 110 permits them to cool to the second temperature (e.g., an annealing temperature) in the temperature list.

Prior to the arrival of the respective droplets in common zone 852C, the control portion 110 causes the common zone 852C to exhibit the second temperature of the temperature list such that upon their arrival at common zone 852C (via parallel transport paths 808A-808D, 809A-809D), the droplets are exposed to the second temperature for 1 second. Thereafter, the control portion 110 heats the common zone 852C to the third temperature of the temperature list for exposure of the droplets to third temperature for a selectable time period (e.g. 3 seconds) to complete the thermal cycle. With the droplets still remaining within common zone 852C, the next thermal cycle begins with further heating the common zone 852C to the first temperature of the temperature list for exposure of the droplets. The rest of this thermal cycle may comprise the actions previously described, and a selectable number of such thermal cycles may be performed via heating of the droplets as they are moved through a circuit including the common zone 852C and the outer zones 852A, 852C until the target selectable number of thermal cycles has been performed.

In some examples, prior to or after performing a target set of thermal cycles in any given set or subset of an electrode pad array, no heat is applied to the heatable zones, and they are permitted to return to an ambient temperature.

In some examples, at least one of the droplets 871A-874A, 871B-874B may be a product of one stage of a process pipeline while a different droplet of the droplets 871A-874A, 871B-871B may be a product of another, different stage of the process pipeline such that droplets of different stages of a process pipeline can be exposed to a temperature phase (of a multiple temperature phase process, e.g., thermocycling) simultaneously within the same heating zone.

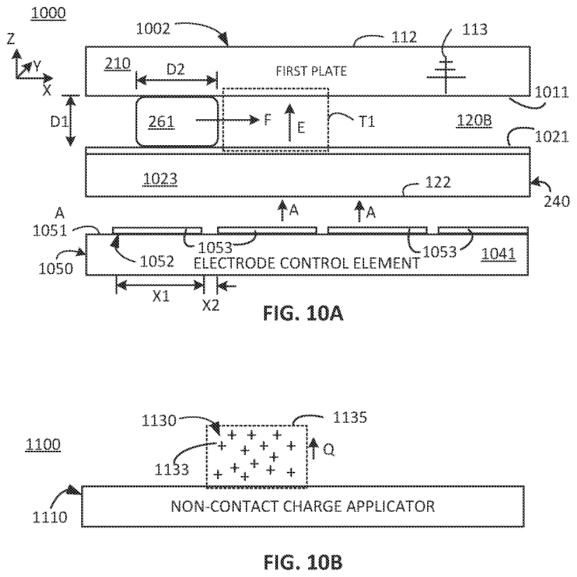

FIG. 10A is a diagram 1000 including a sectional side view schematically representing an example microfluidic device 1002 including a receptacle defining a fluid passageway 120B and an electrode control element 1050. In some examples, the microfluidic device 1002 of FIG. 10A may comprise at least some of substantially the same features and attributes as the digital microfluidic device of FIG. 3 (and also FIGS. 1-9 generally), except comprising an electrode control element 1050 which is releasably couplable relative to the microfluidic receptacle 1005 defining passageway 120B. In some examples, the electrode control element 1050 comprises a substrate 1041 (like substrate 241 in FIG. 3) which supports an array 1052 of electrodes 1053 mounted a surface 1051. Each electrode 1053 may provide a similar function as electrode 253 as described in association with FIG. 3. Accordingly, once the electrode control element 1050 becomes releasably coupled to the microfluidic device 1002, each electrode 1053 may correspond to an electrode pad or electrode pad location of an array of individually controllable electrode pads used to cause electrowetting movement of a droplet (e.g. 261) within and along fluid passageway 120B, as previously described in association with at least FIGS. 1-9.

Via the example arrangement in FIG. 10A, the electrodes 1053 and related circuitry of the electrode control element 1050 may be re-used many times in coordination with single-use or disposable microfluidic receptacles, thereby dramatically reducing the overall cost of testing while also saving materials, time, and effort. In some examples, the substrate 1023 of the second plate 240 of microfluidic device 1002 may comprise additional adaptations such as, but not limited to, preferential conductivity (e.g. anisotropic conductivity) to facilitate transfer of charges from the electrodes 1053 to and through the second plate 240 to create or induce the electric field E across the fluid passageway 120B.

FIG. 10B is a diagram including a sectional side view schematically representing an example non-contact charge applicator 1110, which may be used instead of the electrode control element 1050 (FIG. 10A) apply charges to induce the electric field E (FIGS. 10A, 3). The non-contact charge applicator 1110 may remain spaced apart from the second plate 240 of the microfluidic device 1002 but close enough to be in charging relation to the second plate 240. The non-contact charge applicator 1110 may selectively emit a plurality 1130 of charges 1133 (e.g. ions) in a pattern 1135 and at locations which generally correspond to the size, shape, and location of the electrodes 1053 (FIG. 10A, 3) so induce the electric field E within and across the fluid passageway 120B. In this way, the non-contact charge applicator 1110 effectively creates an array of virtual electrode pads by which the control portion 110 (FIG. 1) can track and/or control electrowetting movement as part of an example method of multi-zone, multiple temperature phase thermal cycling such as, but not limited to, the foregoing examples of FIGS. 1-9. Like the example of FIG. 10A, the re-usable, non-contact charge applicator (e.g. external charge applicator) enables the use of disposable microfluidic receptacles 1002 to dramatically reduce the overall cost of testing, save materials, etc.

FIG. 11A is a block diagram schematically representing an example fluid operations engine 1200. In some examples, the fluid operations engine 1200 may form part of a control portion 1300, as later described in association with at least FIG. 11B, such as but not limited to comprising at least part of the instructions 1311. In some examples, the fluid operations engine 1200 may be used to implement at least some of the various example devices and/or example methods of the present disclosure as previously described in association with FIGS. 1-10B and/or as later described in association with FIGS. 11B-12. In some examples, the fluid operations engine 1200 (FIG. 11A) and/or control portion 1300 (FIG. 11B) may form part of, and/or be in communication with, an addressable electrode pad array and/or a microfluidic receptacle, such as the devices and methods described in association with at least FIGS. 1-10B.

As shown in FIG. 11A, in some examples the fluid operations engine 1200 may comprise a moving function 1202, a merging function 1204, and/or a splitting function 1206, which may track and/or control manipulation of droplets within a microfluidic device, such as moving, merging (e.g., FIG. 7B), and/or splitting (e.g., FIG. 8), respectively, of droplets according to a desired timing and order of operations. Such movement, merging, and/or splitting may be implemented via electrowetting movement via operation of one of the example addressable electrode pad arrays described in association with at least FIGS. 1-10B.

In some examples, the fluid operations engine 1200 may comprise a temperature phase control engine 1220 to track and/or control parameters associated with example methods in which droplets are exposed to a series of selectable temperatures (parameter 1222 or 172 in FIG. 2A) for selectable periods of time (parameter 1224 or 176 in FIG. 2A) within multiple different zones (parameter 1225 or 174 in FIG. 2A). In some such examples, the temperatures may be implemented via a heating parameter 1226 and/or cooling parameter 1228, such as via temperature control element 188 in FIG. 2B or other temperature control elements.

It will be understood that various functions and parameters of fluid operations engine 1200 may be operated interdependently and/or in coordination with each other, in at least some examples.

FIG. 11B is a block diagram schematically representing an example control portion 1300. In some examples, control portion 1300 provides one example implementation of a control portion forming a part of, implementing, and/or generally managing the example digital microfluidic devices, addressable electrode pad arrays, microfluidic receptacles, microfluidic operations, control portion, instructions, engines, functions, parameters, and/or methods, as described throughout examples of the present disclosure in association with FIGS. 1-11A and 11C-12. In some examples, control portion 1300 includes a controller 1302 and a memory 1310. In general terms, controller 1302 of control portion 1300 comprises at least one processor 1304 and associated memories. The controller 1302 is electrically couplable to, and in communication with, memory 1310 to generate control signals to direct operation of at least some of the example digital microfluidic devices, addressable electrode pad arrays, microfluidic receptacles, microfluidic operations, control portion, instructions, engines, functions, parameters, and/or methods, as described throughout examples of the present disclosure. In some examples, these generated control signals include, but are not limited to, employing instructions 1311 stored in memory 1310 to at least direct and manage microfluidic operations in the manner described in at least some examples of the present disclosure. In some instances, the controller 1302 or control portion 1300 may sometimes be referred to as being programmed to perform the above-identified actions, functions, etc.

In response to or based upon commands received via a user interface (e.g. user interface 1320 in FIG. 11C) and/or via machine readable instructions, controller 1302 generates control signals as described above in accordance with at least some of the examples of the present disclosure. In some examples, controller 1302 is embodied in a general purpose computing device while in some examples, controller 1302 is incorporated into or associated with at least some of the example microfluidic devices, addressable electrode pad arrays, microfluidic receptacles, microfluidic operations, control portion, instructions, engines, functions, parameters, and/or methods, etc. as described throughout examples of the present disclosure.

For purposes of this application, in reference to the controller 1302, the term “processor” shall mean a presently developed or future developed processor (or processing resources) that executes machine readable instructions contained in a memory or that includes circuitry to perform computations. In some examples, execution of the machine readable instructions, such as those provided via memory 1310 of control portion 1300 cause the processor to perform the above-identified actions, such as operating controller 1302 to implement microfluidic operations via the various example implementations as generally described in (or consistent with) at least some examples of the present disclosure. The machine readable instructions may be loaded in a random access memory (RAM) for execution by the processor from their stored location in a read only memory (ROM), a mass storage device, or some other persistent storage (e.g., non-transitory tangible medium or non-volatile tangible medium), as represented by memory 1310. The machine readable instructions may include a sequence of instructions, a processor-executable machine learning model, or the like. In some examples, memory 1310 comprises a computer readable tangible medium providing non-volatile storage of the machine readable instructions executable by a process of controller 1302. In some examples, the computer readable tangible medium may sometimes be referred to as, and/or comprise at least a portion of, a computer program product. In other examples, hard wired circuitry may be used in place of or in combination with machine readable instructions to implement the functions described. For example, controller 1302 may be embodied as part of at least one application-specific integrated circuit (ASIC), at least one field-programmable gate array (FPGA), and/or the like. In at least some examples, the controller 1302 is not limited to any specific combination of hardware circuitry and machine readable instructions, nor limited to any particular source for the machine readable instructions executed by the controller 1302.

In some examples, control portion 1300 may be entirely implemented within or by a stand-alone device.

In some examples, the control portion 1300 may be partially implemented in one of the example microfluidic arrangements (e.g. including an addressable electrode pad array) and partially implemented in a computing resource separate from, and independent of, the example microfluidic arrangements (e.g. including an addressable electrode pad array) but in communication with the example microfluidic arrangements. For instance, in some examples control portion 1300 may be implemented on a local computer (e.g., desktop, laptop, tablet, etc.) in communication with the example microfluidic arrangements via wired and/or wireless communication protocols (e.g., WiFi, Ethernet, USB, Bluetooth, etc.). In other instances, in some examples control portion 1300 may be implemented via a server accessible via the cloud and/or other network pathways. In some examples, the control portion 1300 may be distributed or apportioned among multiple devices or resources such as among a server, an example microfluidic arrangement, and/or a user interface.

In some examples, control portion 1300 includes, and/or is in communication with, a user interface 1320 as shown in FIG. 11C. In some examples, user interface 1320 comprises a communication element or other display that provides for the simultaneous display, activation, and/or operation of at least some of the example microfluidic devices, addressable electrode pads, microfluidic receptacles, microfluidic operations, control portion, instructions, engines, functions, parameters, and/or methods, etc., as described in association with FIGS. 1-11B and 12. In some examples, at least some portions or aspects of the user interface 1320 are provided via a graphical user interface (GUI), and may comprise a display 1324 and input 1322.

FIG. 12 is a flow diagram of an example method 1400. In some examples, method 1400 may be performed via at least some of the example microfluidic devices, addressable electrode pad arrays, electrode control elements, microfluidic receptacles, microfluidic operations, instructions, control portions, engines, functions, parameters, and/or methods, etc. as previously described in association with at least FIGS. 1-11C. In some examples, method 1400 may be performed via at least some example microfluidic devices, addressable electrode pad arrays, microfluidic receptacles, microfluidic operations, instructions, control portions, engines, functions, parameters, and/or methods, etc. other than those previously described in association with at least FIGS. 1-11C.

As shown in FIG. 12, in some examples method 1400 comprises performing electrowetting movement of a droplet within a fluid passageway, aligned with a two-dimensional array of controllable electrode pads, through a circuit of multiple different zones of the electrode pads via repeating a sequence. As shown in at 1412, in some examples the sequence of method 1400 comprises exposing the droplet within a current zone of the different zones for a selectable current time period at a current temperature of a list of consecutive temperatures.

At 1414, in some examples the sequence of method 1400 comprises further exposing the droplet within the current zone, for each respective subsequent time period, at each respective subsequent temperature of the list which is greater than the current temperature. It will be understood that upon implementation of a subsequent temperature within the current zone (after implementation of the current temperature in the current zone), from that point this subsequent temperature will be considered to be the current temperature (e.g., within the current zone). It also will be understood that in some examples the method may comprise further exposing the droplet within the current zone to other temperatures for a selectable time period prior to further aspects of the method at 1416 described below.

At 1416, the sequence of method 1400 comprises moving the droplet into a subsequent zone of the different zones when one of the respective subsequent temperatures is less than the current temperature.

In some examples, method 1400 may further comprise, for each respective one of the multiple zones, the last predetermined temperature of the series is greater than a first predetermined temperature of the series of another respective one of the zones.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

1. A digital microfluidic device comprising:
an array of controllable electrode pads alignable with a fluid passageway;
a control portion to cause electrowetting movement of a droplet within the fluid passageway through a circuit of multiple different zones of the electrode pads via iteratively:
exposing the droplet within a current zone of the different zones for a selectable current time period at a current temperature of a list of consecutive temperatures;
further exposing the droplet within the current zone, for each respective selectable subsequent time period, at each respective subsequent temperature of the list which is greater than the current temperature; and
moving the droplet into a subsequent zone of the different zones when one of the respective subsequent temperatures is less than the current temperature.

2. The device of claim 1, wherein the droplet comprises a nucleic acid amplification mixture and the control portion is to cause the list of consecutive temperatures to comprise a first temperature and a second temperature, which exhibit a first substantial temperature difference, and wherein a respective one of the subsequent temperatures in the current zone which has a highest value of the respective temperatures of the list comprises the first temperature of a nucleic acid amplification process and is the last respective subsequent temperature in the current zone prior to the moving the droplet into the subsequent zone.

3. The device of claim 1, wherein the list of consecutive temperatures corresponds to a sequence of temperatures for performing nucleic acid amplification, and wherein the control portion is to cause the list of consecutive temperatures to comprise three different temperatures including:
a first temperature;
a second temperature, wherein the second temperature is a first substantial difference from, and less than, the first temperature; and
a third temperature, and wherein the third temperature comprise a second substantial difference from, and is greater than, the second temperature, and wherein the third temperature comprises a third substantial difference from, and is less than the first temperature,
wherein a respective one of the subsequent temperatures of the list of consecutive temperatures which has a highest value comprises the first temperature.

4. The device of claim 1, wherein the control portion is to cause initiation of the iterations by omitting the further exposing when the initial current temperature in the current zone is the first temperature of the temperature list and there are no subsequent temperatures of the list which are greater than the current temperature.

5. The device of claim 1, wherein the multiple different zones comprise:
at least a pair of the respective different zones in which the respective temperatures of the list are applied; and
a passive zone interposed between the pair of zones and through which the droplet is to move as the droplet travels between the pair of zones.

6. The device of claim 1, wherein the multiple different zones comprises:
a pair of outer zones and a common zone interposed between, and spaced apart from, the outer zones, wherein movement of the droplet occurs between a respective one of the outer zones and the common zone; and
a pair of passive zones with each respective passive zone interposed between the common zone and a respective one of the outer zones.

7. The device of claim 1, the control portion is to cause:
at least during exposure of the droplet to a respective one of the current temperature and respective subsequent temperatures within the respective zones, shuttling the droplet among different electrode pads within a respective one of the zones in which the droplet is present.

8. The device of claim 7, wherein the droplet comprises a first droplet of a plurality of droplets, and the control portion is to cause the exposure of the first droplet to occur as simultaneous exposure of the plurality of droplet within the respective current zone and subsequent zone at the respective temperatures for the respective selectable time periods.

9. The device of claim 8, wherein the control portion is to cause:
maintaining separation of the first droplet from a second droplet of the plurality of droplets within the current zone during the exposing the plurality of droplets and during the moving of the droplets from the current zone of the subsequent zone.

10. The device of claim 8, wherein the control portion is to cause, via the shuttling movement of the droplet back and forth between adjacent electrode pad, the first droplet to become merged with and subsequently separated from a second droplet of plurality of droplets, wherein the second droplet comprises a liquid compatible with the liquid of the first droplet.

11. A digital microfluidic device comprising:
a two-dimensional array of independently controllable electrodes couplable to a consumable microfluidic receptacle including a fluid passageway to receive at least one droplet, the fluid passageway defining a two-dimensional array of electrode locations corresponding the two-dimensional array of electrodes; and
a control portion to cause electrowetting movement of a droplet within the fluid passageway through a circuit of multiple different heating zones of the electrode locations via iteratively:
exposing the droplet within a current heating zone of the different zones for a selectable current time period at a current temperature of a list of consecutive temperatures;
further exposing the droplet within the current heating zone, for each respective selectable subsequent time period, at each respective subsequent temperature of the list which is greater than the current temperature; and
moving the droplet into a subsequent heating zone of the different zones when one of the respective subsequent temperatures is less than the current temperature, wherein upon moving the droplet to the subsequent zone, the subsequent zone of circuit corresponds to a new current zone and the first respective subsequent temperature corresponds to a new current temperature.

12. The device of claim 1, wherein the multiple different heating zones comprises:
a pair of outer heating zones; and
a common heating zone interposed between, and spaced apart from, the outer heating zones, wherein movement of the droplet occurs between a respective one of the outer heating zones and the common heating zone; and
a pair of passive zones with each respective passive zone interposed between the common heating zone and a respective one of the outer heating zones.

13. The device of claim 1, wherein the control portion is to cause the exposure of a plurality of droplets, including the droplet, simultaneously within the respective current zone.

14. A method comprising:
performing electrowetting movement of a droplet within a fluid passageway, aligned with an array of controllable electrode pads, through a circuit of multiple different zones of the electrode pads via repeating a sequence of:
exposing the droplet within a current zone of the different zones for a selectable current time period at a current temperature of a list of consecutive temperatures;
further exposing the droplet within the current zone, for each respective subsequent time period, at each respective subsequent temperature of the list which is greater than the current temperature, wherein the subsequent temperature becomes the current temperature in the current zone; and
moving the droplet into a subsequent zone of the different zones when one of the respective subsequent temperatures is less than the current temperature in the current zone.

15. The method of claim 14, wherein, for each respective one of the multiple zones, the last predetermined temperature of the series is greater than a first predetermined temperature of the series of the another respective one of the zones.
